(19) United States
(12) Patent Application Publication
(10) Pub. No.: US 2010/0080010 A1
(43) Pub. Date: Apr. 1, 2010

(54) Vehicle interior lighting device

(75) Inventors: Yukiko Marui, Aichi-ken (JP); Satoshi Inagaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/585,741

(22) Filed: Sep. 23, 2009

(30) Foreign Application Priority Data
Sep. 29, 2008 (JP) 2008-251891

(51) Int. Cl. B60Q 1/26

(52) U.S. Cl. 362/488

(57) ABSTRACT

A vehicle interior lighting device includes a light source disposed in a vehicle, and a rod-shaped light guiding member including an one end face through which light emitted from the light source is inputted a transparent material, and a transparent material for guiding the inputted light from the one end face to an other end in an axis direction of the rod-shaped light guiding member. The rod-shaped light guiding member includes a first light radiation section for radiating light in a direction perpendicular to the axis direction according to a first illumination pattern to illuminate a first irradiated area in the vehicle, and a second light radiation section for radiating light in the direction perpendicular to the axis direction according to a second illumination pattern different from the first illumination pattern to illuminate a second irradiated area in the vehicle.

The present application is based on Japanese patent application No. 2008-251891 filed on Sep. 29, 2008, the entire contents of which are incorporated herein by reference.

### BACKGROUND OF THE INVENTION

1. Field of the Invention

This invention relates to a vehicle interior lighting device for lighting different interior areas of a vehicle.

2. Description of the Related Art

A light device is known which comprises a light source, and a rod-shaped light guiding member extending in the light emission direction of the light source and having an upper face as a reflecting surface and a lower face as a light emission surface (See e.g., JP-A-2007-179962). The light device is constructed such that the reflecting surface of the rod-shaped light guiding member is provided with light reflecting grooves at predetermined intervals in the extending direction of the rod-shaped light guiding member and, of the light reflecting grooves, a light reflecting groove near the light source is formed at a region except the central part of the reflecting surface at that position.

However, the lighting device of JP-A-2007-179962 has a problem that it can only output a same illumination pattern of light along the axis direction of the light guiding member and, therefore, it is impossible to output different illumination patterns of light according to different areas.

### SUMMARY OF THE INVENTION

It is an object of the invention to provide a vehicle interior lighting device that different areas can be illuminated by only one light source with different illumination patterns according to the areas.

(1) According to one embodiment of the invention, a vehicle interior lighting device comprises:

a light source disposed in a vehicle; and

a rod-shaped light guiding member comprising an one end face through which light emitted from the light source is inputted a transparent material, and a transparent material for guiding the inputted light from the one end face to an other end in an axis direction of the rod-shaped light guiding member,

wherein the rod-shaped light guiding member comprises

a first light radiation section for radiating light in a direction perpendicular to the axis direction according to a first illumination pattern to illuminate a first irradiated area in the vehicle, and

a second light radiation section for radiating light in the direction perpendicular to the axis direction according to a second illumination pattern different from the first illumination pattern to illuminate a second irradiated area in the vehicle.

In the above embodiment (1), the following modifications, changes and a combination thereof can be made.

(i) The rod-shaped light guiding member comprises the first light radiation section and the second light radiation section arranged in this sequence from the one end face, and

the second illumination pattern comprises a wider light distribution characteristic than the first illumination pattern.

(ii) The first light radiation section comprises a notch formed in the rod-shaped light guiding member.

(iii) The second light radiation section comprises a grain finish portion formed on the rod-shaped light guiding member.

(iv) The second light radiation section comprises a coat portion or a print portion formed on the rod-shaped light guiding member.

(v) The first light radiation section and the second light radiation section are formed away from each other.

(vi) The rod-shaped light guiding member comprises an other end face for radiating light in the axis direction to illuminate a third irradiated area in the vehicle.

Points of the Invention

A vehicle interior lighting device according to one embodiment of the invention is constructed such that a notch with relatively low light loss is disposed at a light input side of a rod-shaped light guiding member near a light source, and a grain finish portion with relatively high light consumption is disposed at a light output side of the rod-shaped light guiding member far from the light source. Therefore, the amount of light will not be short at the grain finish portion. In addition, the pinpoint light radiation (or illumination) by using the notch reflection can be conducted together with the wide range light radiation (or illumination) by using the grain finish portion scattering. Furthermore, the plural areas can be illuminated by only one light source with different illumination patterns according to the areas so as to reduce the number of the light source installed in the vehicle to lower the production cost.

### BRIEF DESCRIPTION OF THE DRAWINGS

The preferred embodiments according to the invention will be explained below referring to the drawings, wherein:

FIG. 1 is a perspective view showing a vehicle interior provided with a vehicle interior lighting device in a preferred embodiment according to the invention;

FIG. 2 is a perspective view showing a rod-shaped light guiding member of a first lighting device of the invention;

FIGS. 3A and 3B are cross sectional view showing the first lighting device, wherein FIG. 3A is a cross sectional view at an illumination section for a front passenger seat and FIG. 3B is a cross sectional view at an illumination section for a gear shifter panel;

FIG. 4 is a cross sectional view showing the first lighting device at a center console main body;

FIG. 5 is a perspective view showing a rod-shaped light guiding member of a second lighting device of the invention;

FIGS. 6A and 6B are cross sectional view showing the second lighting device, wherein

FIG. 6A is a cross sectional view at an illumination section for an operation section and FIG. 6B is a cross sectional view at an illumination section for a door switch section;

FIG. 7 is a perspective view showing a rod-shaped light guiding member of a third lighting device of the invention; and

FIGS. 8A and 8B are cross sectional view showing the third lighting device, wherein FIG. 8A is a cross sectional view at an illumination section for a center console section and FIG. 8B is a cross sectional view at an illumination section for a glove box section.

### DETAILED DESCRIPTION OF THE PREFERRED EMBODIMENTS

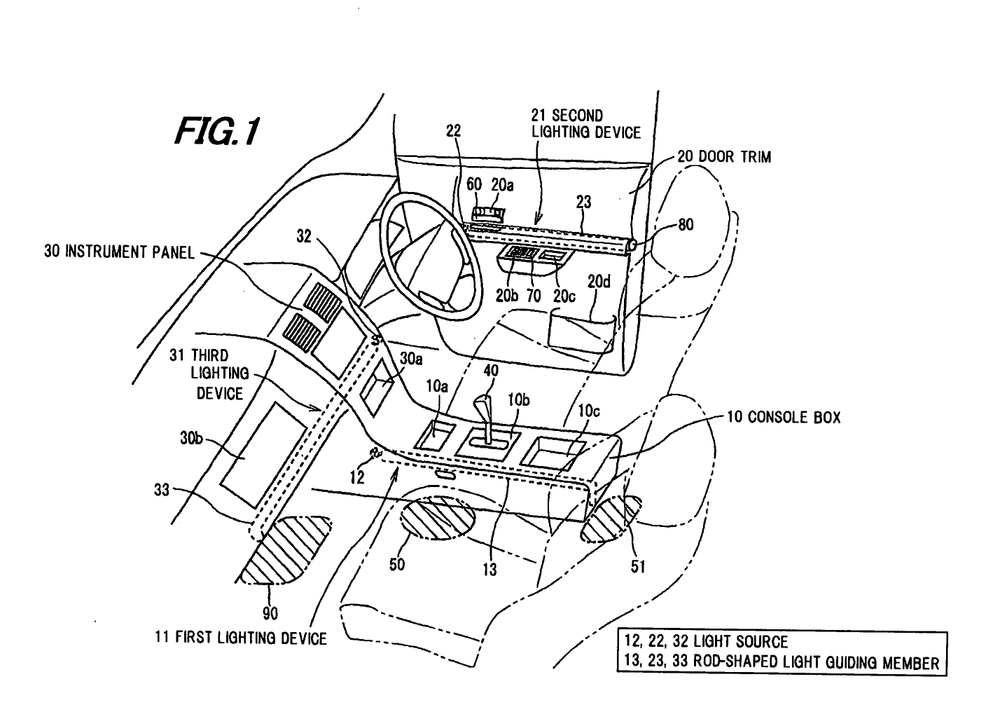

FIGS. 1 to 8 show one embodiment of the invention. FIG. 1 is a perspective view showing a vehicle interior provided with a vehicle interior lighting device in a preferred embodiment according to the invention.

As shown in FIG. 1, the vehicle interior is provided with a console box 10 disposed between a driver seat and a passenger seat, a door trim 20 on the interior side of the vehicle door, and an instrument panel 30 disposed on the front side of the interior. The first lighting device 11 is installed in the console box 10, the second lighting device 21 is installed in the door trim 20, and the third lighting device 31 is installed in the instrument panel 30. The lighting devices 11, 21 and 31 are adapted to illuminate plural areas by light sources 12, 22 and 32, respectively.

The console box 10 is provided with a concave change box 10a, a shift panel 10b for indicating the positions of a shift lever 40, and a concave box main body 10c, which are disposed sequentially from the front side to the rear side. The first lighting device 11 has a rod-shaped light guiding member 13 for guiding light emitted from the light source 12, and the rod-shaped light guiding member 13 is adapted to illuminate the inner area of the change box 10a, the display area of the shift panel 10b and the inner area of the box main body 10c. Furthermore, in the embodiment, the first lighting device 11 is adapted to illuminate a below-knee area 50 of the passenger seat and a footrest area 51 of the rear seat.

The door trim 20 is provided with a concave operating part 20a with a handle 60 for opening the vehicle door, a switch panel 20b for arranging switches 70 such as a power window switch, a door lock switch etc., a concave pull handle 20c, and an open-topped box door pocket 20d, which are disposed sequentially from the front side to the rear side. The second lighting device 21 has a rod-shaped light guiding member 23 for guiding light emitted from the light source 22, and the rod-shaped light guiding member 23 is adapted to illuminate the inner area of the operating part 20a, the display area of the switch panel 20b, the disposition area of the pull handle 20c, and the inner area of the door pocket 20d. Furthermore, in the embodiment, the second lighting device 21 also composes an alarm light 80 disposed at the rear end of the vehicle door.

The instrument panel 30 is provided with an open-back type concave center box 30a and a glove box 30b disposed at the side of the passenger seat, which are disposed sequentially from the driver seat to the passenger seat. The third lighting device 31 is provided a rod-shaped light guiding member 33 for guiding light emitted from the light source 32, and the rod-shaped light guiding member 33 is adapted to illuminate the inner area of the center box 30a, and the inner area of the glove box 30b. Furthermore, in the embodiment, the third lighting device 31 is adapted to illuminate a footrest area 90 of the passenger seat.

First Lighting Device

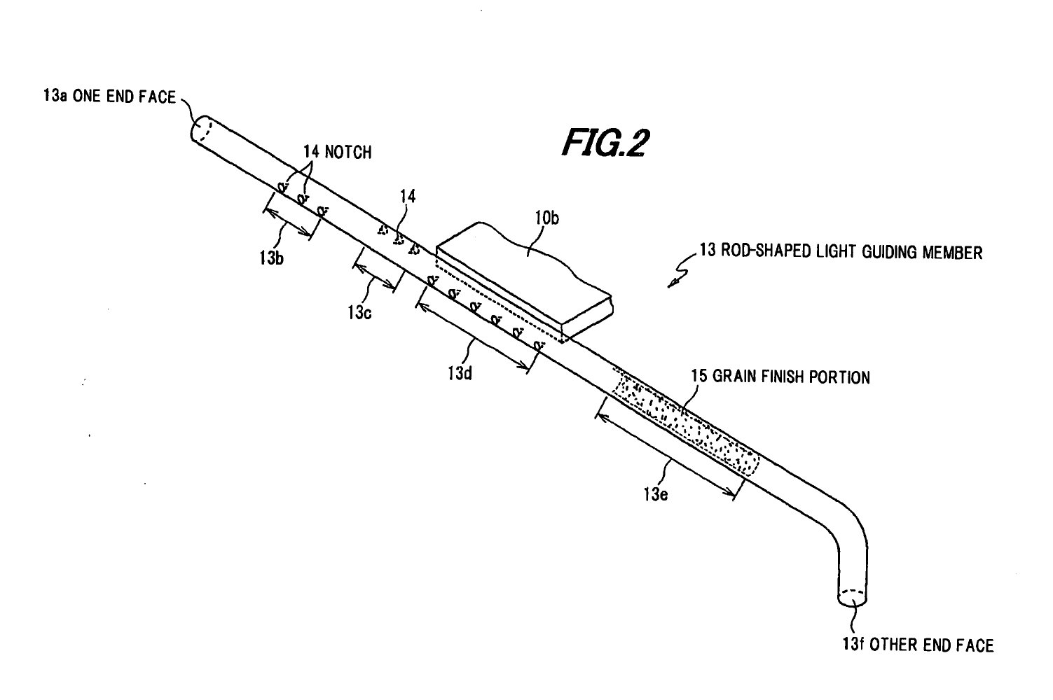

FIG. 2 is a perspective view showing the rod-shaped light guiding member of the first lighting device of the invention.

As shown in FIG. 2, the rod-shaped light guiding member 13 of the first lighting device 11 is formed of a transparent material, has a cylindrical form elongated in the front-back direction, has an end face 13a through which light emitted from the light source is inputted, and is adapted to guide light from the end face 13a to the other end side in the axis direction. The rod-shaped light guiding member 13 is provided with a change box light radiation section 13b for illuminating the inner area of the change box 10a in accordance with a notch illumination pattern, a passenger seat light radiation section 13c for illuminating the under-knee area 50 of the passenger seat in accordance with a notch illumination pattern, a shift light radiation section 13d for illuminating the display area of the shift panel 10b in accordance with a notch illumination pattern, and a box main body light radiation section 13e for illuminating the inner area of the box main body 10c in accordance with a grain finish illumination pattern, which are disposed sequentially from one end. Here, in the first lighting device 11, the notch illumination pattern is referred to as a first illumination pattern, and the grain finish illumination pattern is referred to as a second illumination pattern. The shift panel 10b serves as a light guiding plate, and light radiated from the shift light radiation section 13d can be inputted to the end face of the shift panel 10b. In the embodiment, the sections 13b to 13e are away from one another, and are adapted to output light in the direction perpendicular to the axis direction such that the areas are each individually illuminated. The rod-shaped light guiding member 13 is bent downward at the other end, and the other end face 13f thereof is adapted to output light in the axis direction toward the footrest area 51 of the rear seat. The other end face 13f is roughened to radiate light in a wide range.

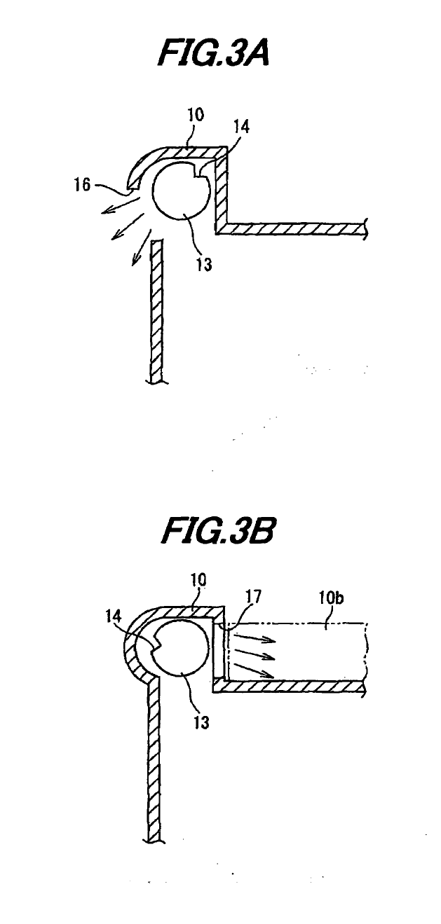

The change box light radiation section 13b, the passenger seat light radiation section 13c and the shift light radiation section 13d are each provided with plural conical notches 14 formed in the rod-shaped light guiding member 13 (as a solid body). As shown in FIGS. 3A and 3B, the notches 14 are each formed at the side opposite the light output direction such that light traveling axially in the rod-shaped light guiding member 13 can be reflected to the light output direction. For example, as shown in FIG. 3A, in order to reflect light toward the passenger seat side, the notches 14 may be formed at the driver seat side. As shown in FIG. 3B, in order to reflect light toward the shift panel 10b side, the notches 14 may be formed opposite the shift panel 10b. As shown in FIG. 3A, light can be outputted to the passenger seat side through an opening 16 formed in the console box 10 and, as shown in FIG. 3B, light can be outputted to the shift panel 10b side through an opening 17 formed in the console box 10. In this embodiment, for each of the sections 13b to 13d, the notches 14 are each arranged in the axis direction at intervals. The conical form of the notches 14 is set to have a suitable diameter and height according to each of the sections 13b to 13d such that different notch illumination pattern can be obtained for each of the sections 13b to 13d.

The box main body light radiation section 13e is provided with a grain finish portion 15 formed on the rod-shaped light guiding member 13. In this embodiment, the grain finish portion 15 is formed on the light output side such that light traveling axially in the rod-shaped light guiding member 13 can be scattered. The grain finish portion 15 can radiate in a range wider than the notches 14, and the grain finish pattern has a wider light distribution characteristic than the notch illumination pattern. Instead, the notches 14 can radiate light at a loss less than the grain finish portion 15.

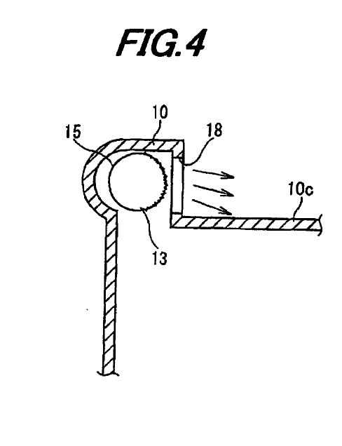

FIG. 4 is a cross sectional view showing the first lighting device at the center console main body. As shown in FIG. 4, in order to output light to the box main body side 10c, the grain finish portion 15 is preferably formed at the side of the box main body side 10c since at the grain finish portion 15, the intensity of light radiated to the normal line, i.e., light radiated to the periphery of the rod-shaped light guiding member 13 is highest. As shown in FIG. 4, light is outputted to the box main body side 10c through an opening 18 formed in the console box 10. Meanwhile, even when the grain finish portion 15 is formed opposite the box main body side 10c, light can be radiated to the box main body side 10c since the grain finish portion 15 also serves to scatter and reflect light.

In the first lighting device 11 constructed as above, when light is inputted from the light source to the rod-shaped light guiding member 13, the inner area of the change box 10a is illuminated by light reflected at the change box light radiation section 13b, the below-knee area 50 of the passenger seat is illuminated by light reflected at the passenger seat light radiation section 13c, the display area of the shift panel 10b is illuminated by light reflected at the shift light radiation section 13d, the inner area of the box main body 10c is illuminated by light scattered at the box main body light radiation section 13e, and the footrest area 51 of the rear seat is illuminated by light outputted through the other end face 13f. Thus, the plural areas can be illuminated by only one light source 12 with different illumination patterns according to the areas so as to reduce the number of the light source 12 installed in the vehicle to lower the production cost.

Further, in the first lighting device 11, the notch 14 with relatively low light loss is disposed at the light input side of the rod-shaped light guiding member 13 near the light source 12, and the grain finish portion 15 with relatively high light consumption is disposed at the light output side of the rod-shaped light guiding member 13 far from the light source 12. Therefore, the amount of light will not be short at the grain finish portion 15. Thus, since the box main body light radiation section 13e is disposed at the light output side which consumes more light than the change box light radiation section 13b, the passenger seat light radiation section 13c, and the shift light radiation section 13d with the notches 14, the pinpoint light radiation (or illumination) by using the notches 14 can be conducted together with the wide range light radiation (or illumination) by using the grain finish portion 15.

Further, in the first lighting device 11, light outputted from the other end face 13f of the rod-shaped light guiding member 13 is used to illuminate the footrest area of the rear seat such that light inputted to the rod-shaped light guiding member 13 can be used without wasting, and the load of the battery of the vehicle can be thereby reduced. Thus, it is very advantageous in practical use. In addition, the first lighting device 11 is constructed such that light can be radiated to the change box 10a, the shift panel 10b and the box main body 10c of the console box 10 and further to the passenger seat side opposite them. Therefore, the number of light sources can be reduced to omit the light source for the passenger seat, whereby the interior space of the vehicle can be enlarged to improve the habitability.

Second Lighting Device

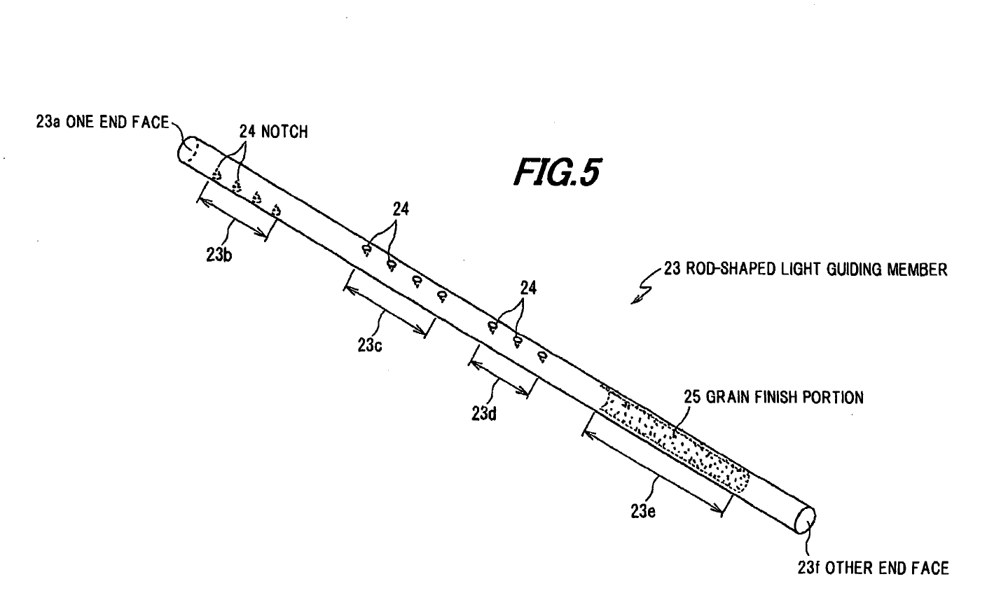

FIG. 5 is a perspective view showing a rod-shaped light guiding member of the second lighting device of the invention.

As shown in FIG. 5, the rod-shaped light guiding member 23 of the second lighting device 21 is formed of a transparent material, has a cylindrical form elongated in the front-back direction, has an end face 23a through which light emitted from the light source is inputted, and is adapted to guide light from the end face 23a to the other end side in the axis direction. The rod-shaped light guiding member 23 is provided with an operating part light radiation section 23b for illuminating the area of an operating part 20a in accordance with a notch illumination pattern, a switch light radiation section 23c for illuminating the installation area of the switch panel 20b in accordance with a notch illumination pattern, a pull handle light radiation section 23d for illuminating the installation area of the pull handle 20c in accordance with a notch illumination pattern, and a door pocket light radiation section 23e for illuminating the inner area of the door pocket 20d in accordance with a grain finish illumination pattern, which are disposed sequentially from one end. In this embodiment, the sections 23b to 23e are away from one another, and are adapted to output light in the direction perpendicular to the axis direction such that the areas are each individually illuminated. The rod-shaped light guiding member 23 is formed linearly from the one end to the other end, and the other end face 23f thereof composes the alarm light 80 at the rear part of the vehicle door.

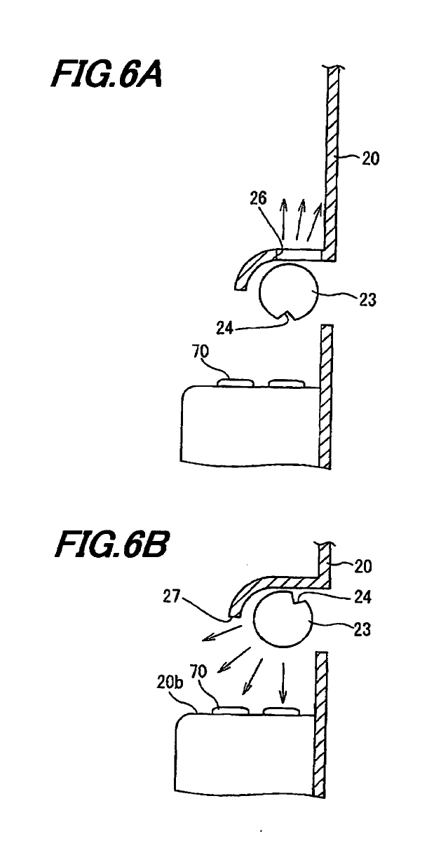

The operating part light radiation section 23b, the switch light radiation section 23c and the pull handle light radiation section 23d are each provided with plural conical notches 24 formed in the rod-shaped light guiding member 23 (as a solid body). As shown in FIGS. 6A and 6B, the notches 24 are each formed at the side opposite the light output direction such that light traveling axially in the rod-shaped light guiding member 23 can be reflected to the light output direction. For example, as shown in FIG. 6A, in order to reflect light upward, the notches 24 may be formed at the bottom side. As shown in FIG. 6B, in order to reflect light toward the switch panel 20b side, the notches 24 may be formed opposite the switch panel 20b. As shown in FIG. 6A, light can be outputted to the operating part 20a side through an opening 26 formed in the door trim 20 and, as shown in FIG. 6B, light can be outputted to the switch panel 20b side through an opening 27 formed in the door trim 20. In this embodiment, for each of the sections 23b to 23d, the notches 24 are each arranged in the axis direction at intervals. The conical form of the notches 24 is set to have a suitable diameter and height according to each of the sections 23b to 23d such that different notch illumination pattern can be obtained for each of the sections 23b to 23d. The door pocket light radiation section 23e is provided with a grain finish portion 25 formed on the rod-shaped light guiding member 23. In this embodiment, the grain finish portion 25 is formed on the light output side such that light traveling axially in the rod-shaped light guiding member 23 can be scattered.

In the second lighting device 21 constructed as above, when light is inputted from the light source 22 to the rod-shaped light guiding member 23, the area of the operating part 20a of the handle 60 is illuminated by light reflected at the operating part light radiation section 23b, the installation area of the switch panel 20b is illuminated by light reflected at the switch light radiation section 23c, the installation area of the pull handle 20c is illuminated by light reflected at the pull handle light radiation section 23d, the inner area of the door pocket 20d is illuminated by light scattered at the door pocket light radiation section 23e, and the alarm light 80 of the vehicle door turns on by light outputted through the other end face 23f. Thus, the plural areas can be illuminated by only one light source 22 with different illumination patterns according to the areas so as to reduce the number of the light source 22 installed in the vehicle to lower the production cost.

Further, in the second lighting device 21, the notch 24 with relatively low light loss is disposed at the light input side of the rod-shaped light guiding member 23 near the light source 22, and the grain finish portion 25 with relatively high light consumption is disposed at the light output side of the rod-shaped light guiding member 23 far from the light source 22. Therefore, the amount of light will not be short at the grain finish portion 25. Thus, the pinpoint light radiation (or illumination) by using the notches 24 can be conducted together with the wide range light radiation (or illumination) by using the grain finish portion 25.

Further, in the second lighting device 21, light outputted from the other end face 23f of the rod-shaped light guiding member 23 is used to alarm the opening of the vehicle door such that light inputted to the rod-shaped light guiding member 23 can be used without wasting. In addition, the second lighting device 21 is constructed such that light can be radiated to the operating part 20a disposed relatively upward and to the switch panel 20b, the pull handle 20c and the door pocket 20d disposed relatively downward. Therefore, the number of light sources can be reduced to improve the freedom degree in design of the door trim 20, whereby the inside wiring of the door trim 20 can be simplified.

Third Lighting Device

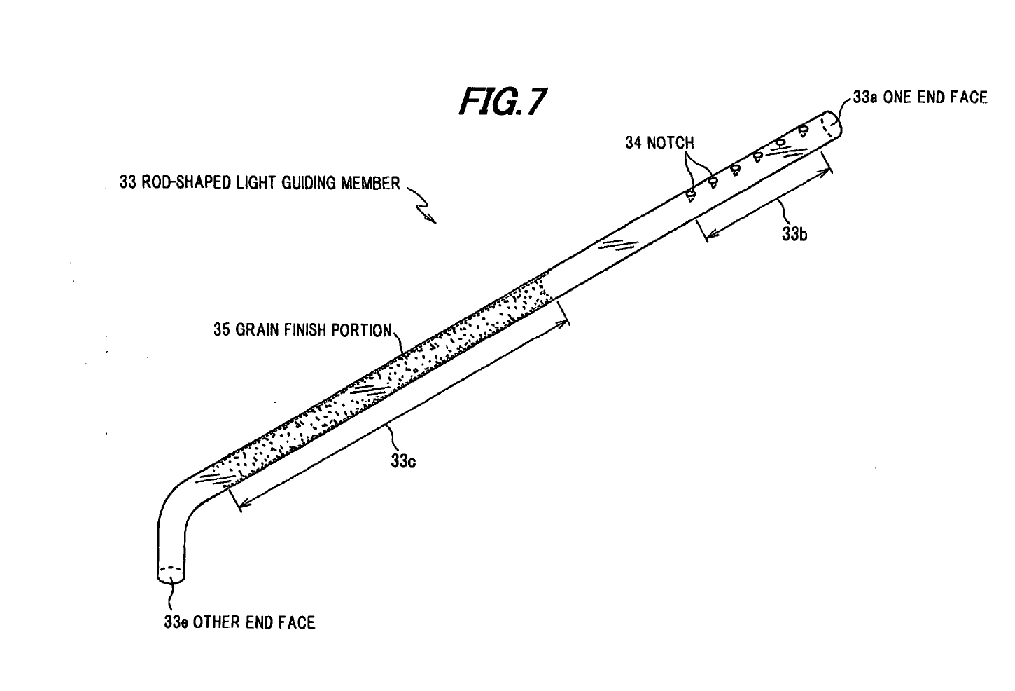

FIG. 7 is a perspective view showing a rod-shaped light guiding member of the third lighting device of the invention.

As shown in FIG. 7, the rod-shaped light guiding member 33 of the third lighting device 13 is formed of a transparent material, has a cylindrical form elongated in the front-back direction, has an end face 33a through which light emitted from the light source is inputted, and is adapted to guide light from the end face 33a to the other end side in the axis direction. The rod-shaped light guiding member 33 is provided with a center box light radiation section 33b for illuminating the inner area of the center 30a in accordance with a notch illumination pattern, and a glove light radiation section 33c for illuminating the inner area of the glove box 30b in accordance with a grain finish illumination pattern, which are disposed sequentially from one end. In the embodiment, the sections 33b and 33c are away from one another, and are adapted to output light in the direction perpendicular to the axis direction such that the areas are each individually illuminated. The rod-shaped light guiding member 33 is bent downward at the other end, and the other end face 33d thereof is adapted to output light in the axis direction toward the footrest area 90 of the passenger seat. The other end face 33d is roughened to radiate light in a wide range.

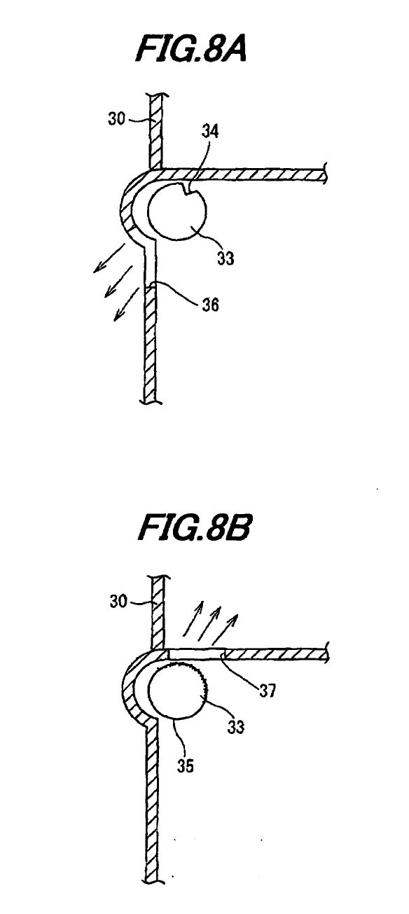

The center box light radiation section 33b is provided with plural conical notches 34 formed in the rod-shaped light guiding member 33 (as a solid body). The notches 34 are formed at the side opposite the light output direction such that light traveling axially in the rod-shaped light guiding member 33 can be reflected to the light output direction. For example, as shown in FIG. 8A, light can be outputted to the center box 30a side through an opening 36 formed in the instrument panel 30. In this embodiment, the notches 34 are each arranged in the axis direction at intervals.

The glove light radiation section 33c is provided with a grain finish portion 35 formed on the rod-shaped light guiding member 33. In this embodiment, the grain finish portion 35 is formed on the light output side such that light traveling axially in the rod-shaped light guiding member 33 can be scattered. As shown in FIG. 8B, light can be outputted to the glove box 30b side through an opening 37 formed in the instrument panel 30.

In the third lighting device 31 constructed as above, when light is inputted from the light source 32 to the rod-shaped light guiding member 33, the inner area of the center box 30a is illuminated by light reflected at the center box light radiation section 33b, the inner area of the glove box 30b is illuminated by light scattered at the glove light radiation section 33c, and the footrest area 90 of the passenger seat is illuminated by light outputted through the other end face 33d. Thus, the plural areas can be illuminated by only one light source 32 with different illumination patterns according to the areas so as to reduce the number of the light source 32 installed in the vehicle to lower the production cost.

Further, in the third lighting device 31, the notch 34 with relatively low light loss is disposed at the light input side of the rod-shaped light guiding member 33 near the light source 32, and the grain finish portion 35 with relatively high light consumption is disposed at the light output side of the rod-shaped light guiding member 33 far from the light source 32. Therefore, the amount of light will not be short at the grain finish portion 35. Further, in the third lighting device 31, light outputted from the other end face 33d of the rod-shaped light guiding member 33 is used to illuminate the footrest area 90 of the passenger seat such that light inputted to the rod-shaped light guiding member 33 can be used without wasting. In addition, the third lighting device 31 is constructed such the number of light sources can be reduced to simplifying the inside wiring of the instrument panel 30.

Although in the above embodiments the rod-shaped light guiding members 13, 23 and 33 have a circular cross section, they may have an arbitrary cross section, e.g., a rectangular cross section. Further, although the notches 14, 24 and 34 have a conical form, they may have an arbitrary form, e.g., a triangular pyramid or a groove form. Instead of the grain finish portions 15, 25 and 35, a white coat or print etc. or a reflective metal may be formed or deposited on the rod-shaped light guiding member. The white coat and print are more in light consumption amount than the notches as well as the grain finish portion.

Although in the above embodiments the lighting device 11, 21 and 31 for the console box 10, the door trim 20 and the instrument panel 30, respectively, are exemplified, the lighting devices of the invention can apply to a roof trim, a trunk room trim etc. in the vehicle.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A vehicle interior lighting device, comprising:
a light source disposed in a vehicle; and
a rod-shaped light guiding member comprising an one end face through which light emitted from the light source is inputted a transparent material, and a transparent material for guiding the inputted light from the one end face to an other end in an axis direction of the rod-shaped light guiding member,
wherein the rod-shaped light guiding member comprises
a first light radiation section for radiating light in a direction perpendicular to the axis direction according to a first illumination pattern to illuminate a first irradiated area in the vehicle, and
a second light radiation section for radiating light in the direction perpendicular to the axis direction according to a second illumination pattern different from the first illumination pattern to illuminate a second irradiated area in the vehicle.

2. The vehicle interior lighting device according to claim 1, wherein
the rod-shaped light guiding member comprises the first light radiation section and the second light radiation section arranged in this sequence from the one end face, and
the second illumination pattern comprises a wider light distribution characteristic than the first illumination pattern.

3. The vehicle interior lighting device according to claim 2, wherein
the first light radiation section comprises a notch formed in the rod-shaped light guiding member.

4. The vehicle interior lighting device according to claim 3, wherein
the second light radiation section comprises a grain finish portion formed on the rod-shaped light guiding member.

5. The vehicle interior lighting device according to claim 3, wherein
the second light radiation section comprises a coat portion or a print portion formed on the rod-shaped light guiding member.

6. The vehicle interior lighting device according to claim 2, wherein
the first light radiation section and the second light radiation section are formed away from each other.

7. The vehicle interior lighting device according to claim 2, wherein
the rod-shaped light guiding member comprises an other end face for radiating light in the axis direction to illuminate a third irradiated area in the vehicle.
